(19) United States
(12) Patent Application Publication
(10) Pub. No.: US 2013/0329609 A1
(43) Pub. Date: Dec. 12, 2013

(54) VOICE CONFERENCE UNIT SELECTION

(71) Applicant: INFINET FINACIAL SYSTEMS, New York, NY (US)

(72) Inventor: HUW RICHARD WILLIAMS, New York, NY (US)

(21) Appl. No.: 13/913,287

(22) Filed: Jun. 7, 2013

Related U.S. Application Data
(60) Provisional application No. 61/656,897, filed on Jun. 7, 2012.

(51) Int. Cl. H04M 3/56

(52) U.S. Cl. CPC H04M 3/56
USPC 370/261

(57) ABSTRACT

A conferencing system provides selection of a mixer from among a pool of mixers for a conference. The selection may be based on querying the pool of mixers for availability and mixing capacity and determining from the response which of the signal mixers provides optimal mixing for the conference. In some embodiments, software resident on terminals or on a centralized server in the conferencing system may provide instructions for determining which of the mixers provides the optimal mixing performance under requirements of the teleconference.

### CROSS-REFERENCE TO RELATED APPLICATIONS

This application claims benefit under 35 U.S.C. §119(e) of U.S. Provisional Application having No. 61/656,897 filed Jun. 7, 2012, which is hereby incorporated by reference herein in its entirety.

### BACKGROUND

In fast paced communications environments, many parties to a conference, for example, a teleconference may need to be connected. The origination or type of each participant's connection may be dissimilar to other participants' calls and thus the audio signal quality for each party may differ. Some solutions include using a software-based audio mixer to process the different audio streams. In some teleconferencing environments, the number and size of teleconferences happening simultaneously may present a challenge in determining which audio mixers may be best suited to process any given teleconference.

As may be seen, there is a need for a system that selects the optimal mixer for a conference.

### SUMMARY OF THE INVENTION

In one aspect of the present invention, a system comprises a plurality of terminals adapted for conferencing; and a controller coupled with at least one of the plurality of terminals, the controller configured to: send a query to a plurality of data stream signal mixers in the system to obtain information corresponding to signal mixing capacity for a conference, receive the information from the plurality of signal mixers, and select, based on a current signal mixing capacity of a respective signal mixer of the plurality of signal mixers, an optimal one of the plurality of signal mixers for use in mixing data streamed in the conference.

In another aspect of the present invention, a computer program product for selecting an audio signal mixer for a voice conference between terminals, the computer program product comprising a non-transitory computer readable storage medium having program code embodied therewith, the program code readable/executable by a processing device to: identify available signal mixers in a network; identify resource requirements of the conference; query the available signal mixers for signal mixing capacity; determine from responses provided by the signal mixers, which of the available signal mixers has an optimal capacity for providing signal mixing of the conference under the identified resource requirements; and select the signal mixer of the available signal mixers with the optimal capacity to provide signal mixing of the conference.

These and other features, aspects and advantages of the present invention will become better understood with reference to the following drawings, description and claims.

### BRIEF DESCRIPTION OF THE DRAWINGS

FIG. 1 is a schematic diagram of a system for audio teleconferencing according to an exemplary embodiment of the present invention;

FIG. 2 is a block diagram of a terminal used in the system of FIG. 1;

FIG. 3 is a schematic diagram of a terminal querying mixers in the system of FIG. 1; and

FIG. 4 is a schematic diagram of mixers providing response to the queries of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a mechanism for dynamically selecting optimal conferencing data stream component(s). Conference related data streams may include, for example, audio, video, text, or file related data that may be transmitted in communication between endpoints of a meeting conference. Embodiments of the invention may be beneficial to applications such as a commodity trading room or a command and control environment. In exemplary embodiments, conferencing units or data stream mixers (referred to in general as mixers) may be selected to maximize, for example, voice quality, video quality, availability and up-time of teleconferences. The mixers may be part of a standalone conferencing system, part of a more specific Voice over IP (VoIP) solution such as an Adaptive Trading Platform (ATP), or part of a similar trading room or command and control voice platform. Some exemplary embodiments may use or take the form of computer readable media. The computer readable media may be stored on non-transitory media and may be read and/or executed by a processing device.

An optimal mixer(s) selection process may happen when, for example, a call or video meeting is first initiated, is restored, or during an existing call or meeting when an additional (or replacement) mixer is required for the conference. Call restoration may happen when one or more participants in a conference are temporarily disconnected and subsequently re-established. The need for an additional mixer may happen when a mixer fails or the capacity of an existing mixer is approaching a limit.

According to some exemplary embodiments, the mixers may be used in environments including a voice recording server, a voice gateway, a hardware based phone or turret (sometimes called a terminal), a software based phone or turret, an audio mixing component, and phone or turret download profiles, for example. Voice streams may originate from internal sources such as turrets (physical and virtual), phone handsets, mobile devices, automated systems such as interactive voice response (IVR) technology or sound sources music on hold (MOH), tone generators etc., gateways connected to external public switched telephone network (PSTN) gateways (using such protocols as T1, E1, PRI, BRI or analog), or to session boundary controllers (SBCs) connecting to remote voice networks. Mixers under some embodiments may use a proprietary protocol, SIP protocol, or Industry Standard H.323 protocol to setup calls, though other similar VoIP (Spell out) protocols such as IAX2 may be used.

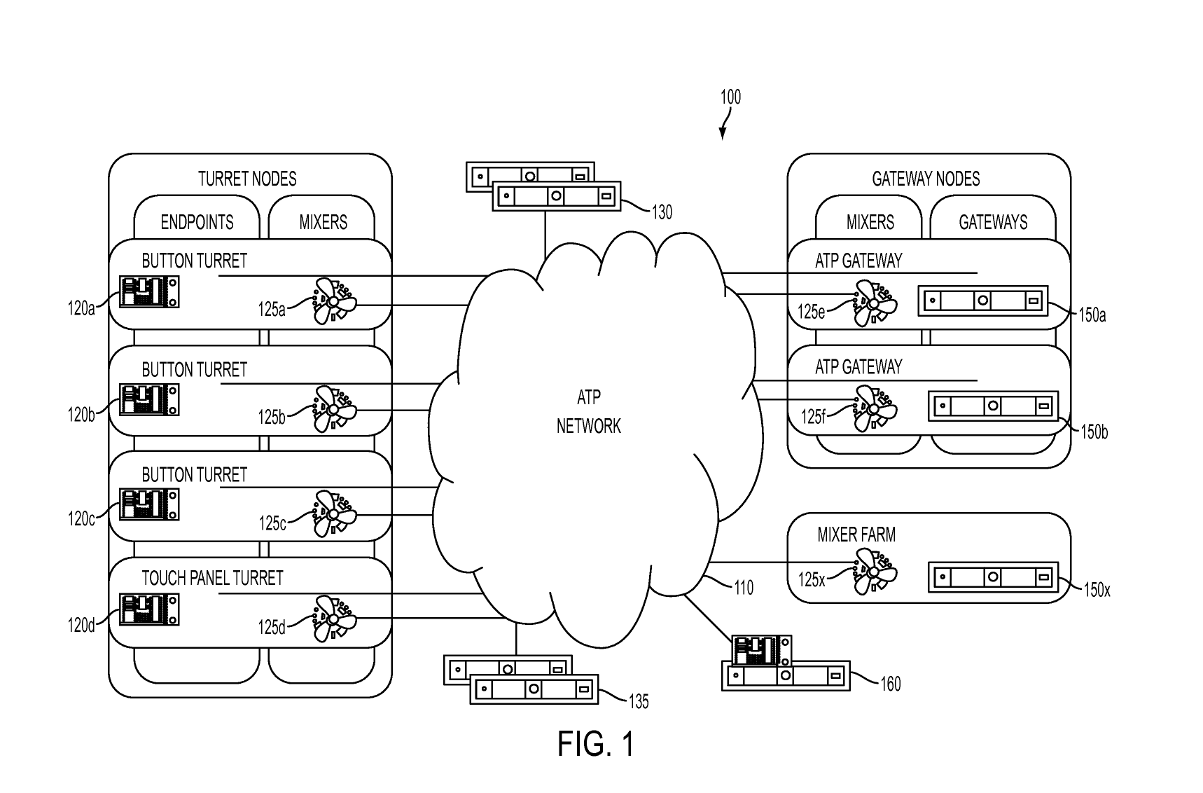

Referring now to FIG. 1, a system 100 for providing teleconferencing is shown according to an exemplary embodiment of the present invention. Data being transferred through the network 110 may use the real-time transport protocol (RTP). In some embodiments, the system 100 may be configured to process ATP data through the network 110. The network 110 may be connected to the PSTN 190 through ATP gateways 150, a voice recording gateway 155 and message gateways 160. A bank 170 of data exchange modules (172; 174; 176; 178; 182; 184) may translate and carry data from respective interfaces with the network 110 to the PSTN 190.

In an exemplary embodiment, one or more conference mixers 125ₐ-125_{f} and 125ₓ (referred to in general as mixer(s) 125) may provide data stream mixing (for example of audio signals or other multimedia type signal) to participants of a conference meeting communicating through electronic means (for example, via a teleconference or videoconference). Participants in the meeting may communicate via terminals 120 (shown as terminals 120ₐ-120_{d}) (sometimes referred to as “turrets” for example, as may be used in a trading room environment) connected to one or more of the mixers 125. In some embodiments, the terminals 120 may be connected together in a peer-to-peer fashion. Thus, control signals may be sent directly from and received directly by each of the terminals 120 participating in the meeting.

When bringing a terminal 120 into the system 100, the terminal 120 may be connected to a configuration server 130. The configuration server 130 may store computer readable programs and data, and computer executable instructions which may be loaded into the terminal 120 allowing it to communicate with other terminals 120. In some embodiments, the system 100 may include a morning call server 135, for example, in applications where the system 100 is used for large scale conferencing for trading. The morning call server 135 may employ both a two-way transmission and a one-way broadcast or multi-cast transmission of audio data to the terminals 120.

In some embodiments, the system 100 may include virtualized terminals 140. The virtualized terminals 140 may be software applications run on an electronic platform that is not a dedicated terminal 120. For example, the virtualized terminals 140 may be programs run on a PC, a mobile phone, a tablet or other computing device with a user interface. The terminals 120 may be configured to communicate with the virtualized terminals 140 as though the virtualized terminals 140 were terminals 120.

The selection of which of the mixer(s) 125 to use for a teleconference is described in further detail in the following.

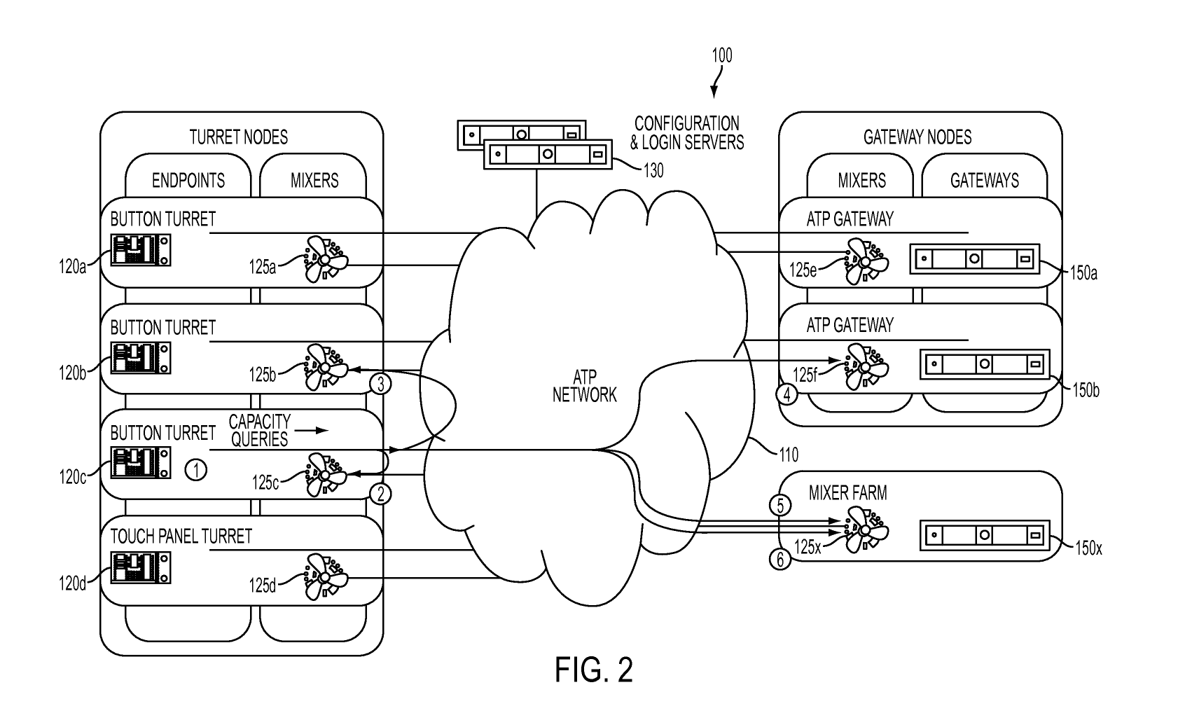

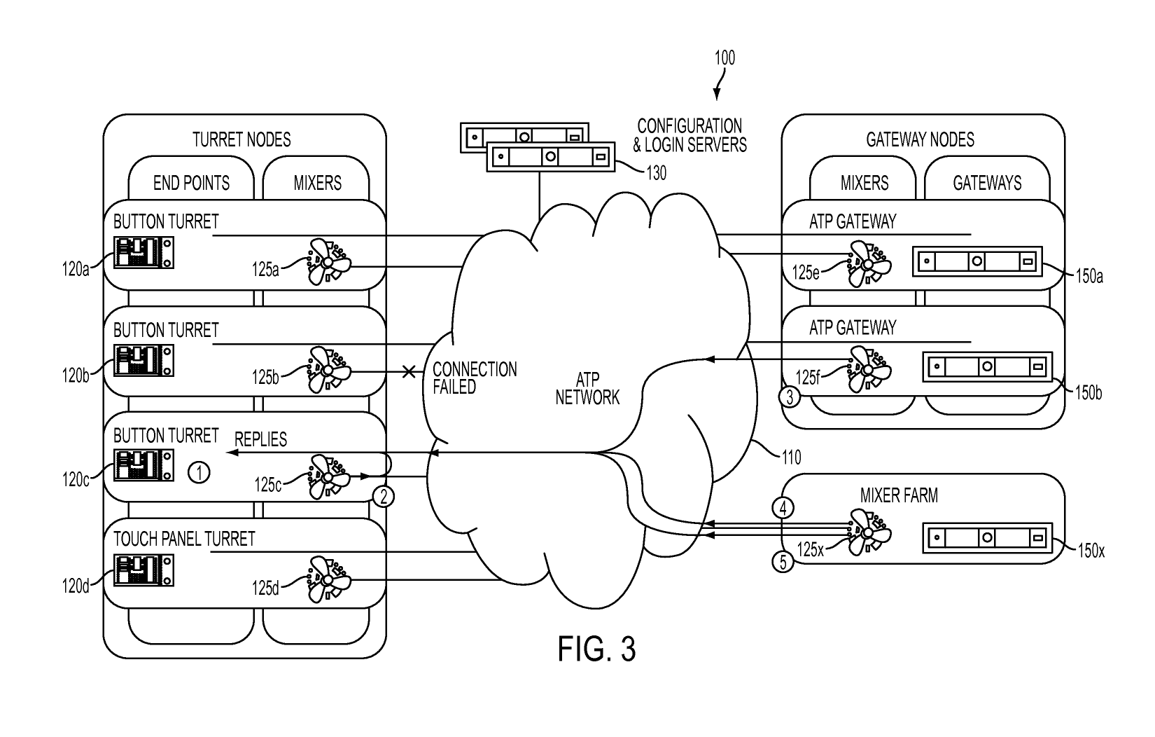

In FIG. 2, an example querying scheme is shown. In FIG. 3, an example response scheme to the query of FIG. 2 is shown.

Referring to FIG. 2, terminals 120ₐ-120_{d} (referred to in general as terminals 120) are shown in communication with their corresponding mixers 125ₐ-125_{d} (referred to in general as mixers 125). Gateway servers 150ₐ and 150_{b} (referred to in general as servers 150) may be in communication with their corresponding mixers 125ₑ and 125_{f}. One or more servers 150ₓ, which are not necessarily gateway nodes, may be in communication with their corresponding mixers 125ₓ. While only a single server 150ₓ and mixer 125ₓ is shown, it will be understood that multiple servers 150 may correspond to the mixers 125 in the mixer farm. It will also be understood that the server 150ₓ may represent other devices connected to the network 110 as described, for example, in FIG. 1. The terminals 120 may participate in a teleconference with entities (not shown) connected in via the servers 150.

During initiation of the teleconference or to bring a party into an existing call, one of the terminals 120, for example, 120_{c} may send out a query to one or more mixers 125 to determine which mixer 125 may be optimal for providing audio mixing of the teleconference. For example, queries may be sent to mixers 125_{c}, 125_{b}, 125_{f}, and 125ₓ. As shown, the query to mixer 125ₓ may involve more than one query to the mixers in the mixer farm.

Referring to FIG. 3, responses from the mixer(s) 125 queried may be received. The response may include for example, information corresponding to the responding one of mixer(s) 125. In some cases, a response may not be received because of some issue in the system 100. For example, as shown, mixer 125_{b} may not be connected to the network 110 and thus a response to terminal 125_{c} could not be provided. A configurable time parameter may be defined within which of mixers 125 should respond to queries. If so defined, responses received after this time period will be disregarded.

Referring in general to FIGS. 2 and 3 again, the selection mechanism of mixer(s) 125 may include a unique set of software algorithms that use for example, a dynamic list of available ones of mixers 125 (for example, the list of mixers 125 may be updated periodically as mixers 125 are used to capacity or capacity is released or additional mixers are added to the pool) and a real-time concurrent or rapid sequential (or some combination of the two) query of the available ones of mixer(s) 125 to retrieve current mixing capacity on each of the mixer(s) 125.

Available ones of mixers 125 may be identified by maintaining a map of mixers 125 that are running and are available for use. This may be stored either centrally or in a distributed architecture where each endpoint (for example, the terminals 120, servers 150, etc.) that uses mixers 125 may store the map after periodic updating of the full mixer topology and capacity availability from either or both of distributed and centralized sources.

In some embodiments, the one of mixer(s) 125 may conference or mix anywhere from two to many hundreds of voice streams simultaneously. In addition, the one of mixers 125 may need to stream extra RTP streams to IP voice loggers. One of the mixers 125 may run acoustic echo cancellation and deal with other audio processing work such as wide bandwidth CODEC's, compression, volume control, and muting, for example.

In some embodiments, multiple mixers 125 may be used for a teleconference to provide a failsafe mechanism to one of the mixer(s) 125 failing during a call. In embodiments with redundant mixers 125 being used, the selection of mixers 125 for a call may be based on which mixers 125 provide the most redundant combination when paired together for the teleconference.

The determination of mixing capacity on one of the mixers 125 may be calculated by checking current available resource capacity (particularly, but not exclusively compute capacity) on one of the mixers 125 and comparing the mixer capacity to the resource requirements of the teleconference. The resource requirement may be determined by evaluating the expected size and complexity of the audio signal mix for the teleconference (for example, evaluating the number of voice streams in and out of the teleconference, Codecs used, compression used, security, encryption and any other resource intensive function to be performed). The choice of which of mixers 125 to be used may be made based on which mixers 125 are best able to perform under the requirements with less signal latency and bandwidth consumed. In some embodiments, one of the mixers 125 may be selected based on being able to provide the best network connectivity for the media flows that will be used during the teleconference.

The mixer(s) 125 may use two or more redundant network connections, which may also use different Ethernet (or other network architecture) devices for interfacing to the VoIP network to further improve reliability, and there may be enough DSP power to support conferencing, echo cancellation, compression, and wideband CODEC's.

The mixers 125 may also run concurrently (i.e. on the same hardware or virtual platform) with gateway, turret, phone, voice recording or other functions.

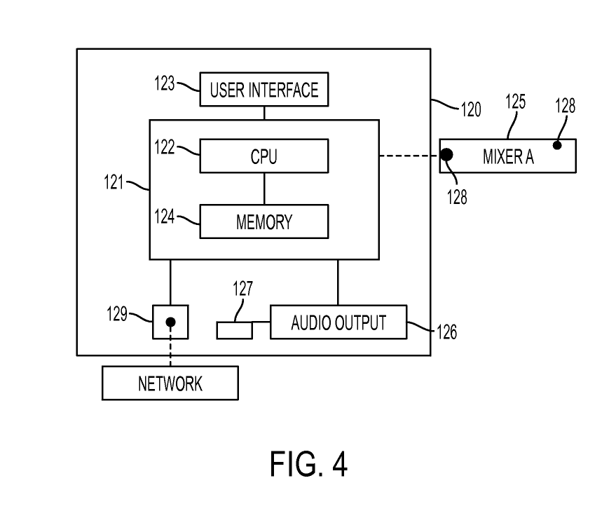

Referring now to FIG. 4, the terminal 120 may include a controller 121, a communication interface port 129 adapted to transmit and receive audio data signals, and a user interface 123. The controller 121 may include a processing device 122 (e.g. a processor or CPU) and memory 124 storing instructions configured for execution by the processing device 122. An audio output module 126 may provide the processed audio data to an output interface 127 (e.g. a speaker). It will be understood that in some embodiments, other endpoints in the system 100, for example servers 150 may use a similar configuration as shown for the terminal 120 and thus the processing device 122 may perform actions associated with exemplary embodiments of the present invention at any of the endpoints. The actions described above may be performed by the processing device 122 executing computer readable instructions unless otherwise noted.

One or more mixers 125 may be in communication with the terminal 120. The mixer 125 may be entirely software operating as a set of mixer instructions 128 in and/or between terminals 120 in the system 100. The set of mixer instructions 128 are shown as part of the mixer 125 however it will be understood that the set of instructions 128 may be resident within the controller 121 of respective terminals 120 in communication with each other. In an exemplary embodiment, the system 100 may include multiple mixers 125 available for any given teleconference convening within the system 100.

It should be understood, of course, that the foregoing relates to exemplary embodiments of the invention and that modifications may be made without departing from the spirit and scope of the invention as set forth in the following claims.

What is claimed is:

1. A system, comprising:
a plurality of terminals adapted for conferencing; and
a controller coupled with at least one of the plurality of terminals, the controller configured to:
send a query to a plurality of data stream signal mixers in the system to obtain information corresponding to signal mixing capacity for a conference,
receive the information from the plurality of signal mixers, and
select, based on a current signal mixing capacity of a respective signal mixer of the plurality of signal mixers, an optimal one of the plurality of signal mixers for use in mixing data streamed in the conference.

2. The system of claim 1, wherein the controller is configured to select from the plurality of signal mixers a signal mixer with a least signal latency as the optimal signal mixer.

3. The system of claim 1, wherein the controller is configured to select from the plurality of signal mixers a signal mixer with a least bandwidth consumed as the optimal signal mixer.

4. The system of claim 1, further comprising data storage including a dynamic map of the plurality of signal mixers available for signal mixing in the teleconference.

5. The system of claim 1, wherein the controller is configured to select two or more of the plurality of signal mixers as optimal signal mixers to provide redundant signal mixing of the teleconference.

6. A computer program product for selecting a signal mixer for a conference between terminals, the computer program product comprising a non-transitory computer readable storage medium having program code embodied therewith, the program code readable/executable by a processing device to:
identify available signal mixers in a network;
identify resource requirements of the conference;
query the available signal mixers for signal mixing capacity;
determine from responses provided by the signal mixers, which of the available signal mixers has an optimal capacity for providing signal mixing of the conference under the identified resource requirements; and
select the signal mixer of the available signal mixers with the optimal capacity to provide signal mixing of the conference.

7. The computer program product of claim 6, the program code being readable and executable by the processor to determine from the available signal mixers, a pair of signal mixers that occurs as a most redundant combination of signal mixers with the optimal capacity for providing signal mixing of the teleconference.

8. The computer program product of claim 6, wherein the program code is resident on the terminals.

9. The computer program product of claim 6, the program code being readable and executable by the processor to select the signal mixer with the optimal capacity based on which of the available signal mixers provides the best network connectivity for media flows used during the conference.

10. The computer program product of claim 6, wherein the signal mixers are configured to mix audio signals in a teleconference.
